(19) United States
(12) Patent Application Publication
(10) Pub. No.: US 2010/0123415 A1
(43) Pub. Date: May 20, 2010

(54) Emulating light emission systems

(75) Inventor: Nathanael Jefferson Webb, Loveland, CO (US)

Correspondence Address: LAW OFFICE OF CHAD C. SOLIZ , LLC, 407 N. Lincoln Ave. Ste. 105, LOVELAND, CO, 80537, US

(73) Assignee: Blazen Illuminations, LLC, Loveland, CO (US)

(21) Appl. No.: 12/313,518

(22) Filed: Nov. 20, 2008

(51) Int. Cl. H05B 37/02

(52) U.S. Cl. 315/297

(57) ABSTRACT

The present invention is a fire fly emulation apparatus and method that functionally provides control of fire fly light emission emulation at each of the one or a plurality of light sources, in preferred embodiments LEDs. In some embodiments, the invention features integrated circuitry to each of the LEDs that affords accurate control of emulation of light emission of fire flies, or other light sources in some embodiments, such as timing, duration, delay, decay, ramping and fade emission control. In some preferred embodiments, the invention features transistors monolithically integrated with the LED. In still further embodiments control of current is provided to a plurality of LED light sources. The present invention affords preferable costs in manufacturing in a mechanically and electrically simple design embodied as fire fly emulation systems as both apparatus and method embodiments. The features of the present invention serve to provide embodiments that have applicability in decoration or other functional light display, generally, while providing preferred control that may not only emulate fire flies, but other light emissions.

### BACKGROUND OF THE INVENTION

The present invention relates to technology emulating the light emissions of living species such as insects, including but not limited to fire flies and other such insects, and technology having a one or a plurality of light sources for decorative or other functional display.

Technologies attempting to emulate fire flies are generally well known, particularly in the application of multiple light sources and motion, as well as in the basic control of the light generally. One such technology exemplified in U.S. Pat. No. 7,212,932 issued to Taylor, may provide a sophisticated approach to accurately mimicking light emissions of the bioluminescent abdominal ‘lantern’ of the species of the Lampyridae Family. The Taylor Patent provides a significant summation of traditional technologies that had been developed to imitate the light emissions of fire flies.

One such technology incorporates incandescent lamps that are each attached to a disc that is suspended by wires to allow for movement of the lamp and disc when a flow of air is directed at the lamps. The movement of the lamps and discs create a rudimentary fire fly effect when viewed from a distance as the lamp and discs movement simulate the movement of fire flies and an on/off effect intended to simulate similar to light emissions of fire flies. Another described technology incorporates a suspended wire having a fan attached along the wire and an LED (light emitting diode) at the end of the wire, such that when the traditional technology is powered, the fan creates movement of the LED. The LED may be covered with opaque material such that only a small window is provided for light emission. Thus the rudimentary fire fly effect is created by movement of the LED and on/off effect created when viewed from a distance and the limited light-emitting window as the window moves in and out of the field of view of the observer.

The Taylor Patent, however, seeks to more accurately represent actual fire fly light emissions in a traditional technology having programmed control of the light emission with distinct and separate controller and light emitting devices. The controller receives software into its memory that is converted fire fly information to be read and processed by the controller, including the requirement for a timer, memory and processor as part of the controller. The controller then directs control signal output to a separate light emitting device or devices.

The limitations inherent with the first systems described in the Taylor Patent are the apparent requirement for movement of a portion or all of these traditional systems in order to crudely represent light emissions of fire flies. Technologies having a movement feature may form a complicated system of component parts that may not only unnecessary increase the cost of such technologies but further complicate the installation and implementation of system. As an example, these technologies incorporate air flow generating devices to ensure movement of the light sources, increasing cost and complexity of installation and operation. Second, these traditional technologies may not represent sufficiently the light emissions of fire flies in that it would not appear that the actual movement and on/off effects of the fire fly are not accurately represented by their apparent random movement of the light sources and random light effects.

The technology of the Taylor Patent, moreover, may even be seen as a departure away from a more concise and simple mechanical and electrical design in the attempt to more accurately represent the light emissions of fire flies. The apparent recognized need in the field was to better represent fire flies in a decorative or other functional display and to better emulate fire fly light emissions. However, in providing a more sophisticated approach to incorporate information on light emissions of fire flies, the Taylor technology creates a more burdensome technology with controller features that increase the size, complexity and programmed complexity of the emulation of fire fly light emissions. It would appear that in attempting to address the rudimentary representation of past technologies, the Taylor Patent actually teaches away from simplifying the electrical design that might be achieved as a sacrifice to achieving a less mechanical approach.

Other recent yet traditional technologies have been developed that follow upon the basic Taylor Patent approach, such as may be found in systems that have independent controllers from which a plurality of light sources such as LEDs extend. In an apparent effort to reduce the costs of such fire fly systems, traditional technologies have provided basic on/off control of each LED with relatively complex circuitry located at the light source, such as having circuit boards or integrated circuitry (IC) in electrical connection with the LEDs.

However, these traditional technologies, while in apparent attempt to address concerns with technologies such as described in the Taylor Patent, are limited in that the representation of the fire fly light emulation remains rudimentary in simple, on/off light emissions without advanced control that would more closely represent a fire fly and address concerns previously raised by the Taylor Patent. These technologies, although attempting to simplify the electrical design, retain rudimentary representations of fire flies and their movement and light emissions. It may have been not fully understood that the more accurate representation of light emission, expressed as an apparent need in the Taylor Patent, might still be achieved in a concise mechanical and electrical design that could keep the system costs reasonable while affording a technology that is simple to install, operate and maintain.

The present invention seeks to overcome one or more of these and other deficiencies of the prior art.

### SUMMARY OF THE INVENTION

The present invention affords preferable costs in manufacturing in a mechanically and electrically simple design embodied as fire fly emulation systems as both apparatus and method embodiments. The features of the present invention serve to provide embodiments that have applicability in decoration or other functional light display, generally, while providing preferred control that may not only emulate fire flies, but other light emissions, in a technology having the control of the emulation of light emission provided by the light source, and in preferred embodiments, control at each LED. The emulation of light emission may be more advanced beyond simple on/off control to allow for more accurate emulation of fire flies and other light emissions.

Accordingly, in some embodiments, the present invention is a fire fly emulation apparatus and method that functionally provides control of fire fly light emission emulation at each of the one or a plurality of light sources, in preferred embodiments LEDs. In some embodiments, the invention features integrated circuitry to each of the LEDs that affords accurate control of emulation of light emission of fire flies, or other light sources in some embodiments, such as timing, duration, delay, decay, ramping and fade emission control. In some preferred embodiments, the invention features at least one transistor monolithically integrated with the LED.

In accordance with still further embodiments, the present invention is a fire fly emulation apparatus and method that functionally provides control of fire fly light emission emulation at each of the one or a plurality of light sources, in preferred embodiments LEDs, through control of current provided to a plurality of light sources, and in preferred embodiments, the provision of current corresponding to the number of LEDs. In some embodiments, an adjustable resistance element control of current provided to a plurality of LED light sources.

In some embodiments, the present invention is a fire fly emulation apparatus and method that functionally provides in combination with other features of the invention emulation of the fire fly body or other light source element, having a light source body and light emission that realistically emulates the fire fly or other light source. Again, the emulation may be created by one or a plurality light sources such as LEDs.

Still other apparatus and methods are also disclosed as embodiments of the invention in the present application. Application of the invention may include the decoration and other functional display of light sources and light emission, such as in the application of wired light displays having advanced control for the emulation of fire flies and other light sources, and may be provided in combination with other display or decoration technologies. Other embodiments of the present invention further emulate a group of fire flies, or a plurality of fire flies, having preferred control features at each light source in emulation of a fire fly so that collective control of emulation of light emission of fire flies is collectively provided by the plurality of light sources in emulation of the group of fire flies.

### BRIEF DESCRIPTION OF THE DRAWINGS

FIG. 1 is a schematic view of an embodiment of the present invention.

FIG. 2 is a schematic view of another embodiment of the present invention.

FIG. 3 is a schematic view of a yet another embodiment of the present invention.

### DETAILED DESCRIPTION OF PREFERRED EMBODIMENTS OF THE INVENTION

The present invention is described in preferred embodiments that address one or more inadequacies of the prior art. Accordingly, embodiments of the invention are shown and described in the Figures, written description, and throughout the disclosure of this application.

The present invention in preferred embodiments is a technology having capabilities of and the application for decoration and other functional display of light sources and light emission, such as in the application of wired light displays having advanced control for the emulation of fire flies and other light sources, and may be provided in combination with other display or decoration technologies.

Particular advantages stem from the present invention and in relation to the prior art and are described above in the summary of the invention and in respect to at least those recognized needs and inabilities or lack of features identified in the prior art. One objective and advantage achieved by the present invention over traditional technologies is the emulation of light emission of fire flies in a system, both apparatus and process, that more advantageously emulates fire flies in comparison to more rudimentary on/off traditional technologies. More accurate emulation may be obtained by the present invention.

Furthermore, the present invention provides the control of the emulation of light emission of a fire fly at the light source, and in preferred embodiments, the control of the emulation of light emission of a fire fly by the light source itself. Advantageously the system, both apparatus and process, is simplified in both mechanical and electrical design, potentially affording a more efficient and less complex installation and operation of the technology. As but one example, the more advanced emulation of fire flies by the present technology will not require a separate system such as a controller required to control light emission from light sources. A more easily operable and more cost effective design may be achieved by the present invention light of previous technologies such as the Taylor Patent.

It may be that in the recognition of a need for more accurate emulation of fire flies from more rudimentary technologies that traditional technologies such as the Taylor Patent and others actually teach away from more efficient electronic design in an effort to better emulate light emissions of a fire fly by relatively complex hardware and software design that may only serve to increase the associated costs of the technology while also potentially creating a less desirable and more complex system to install and operate.

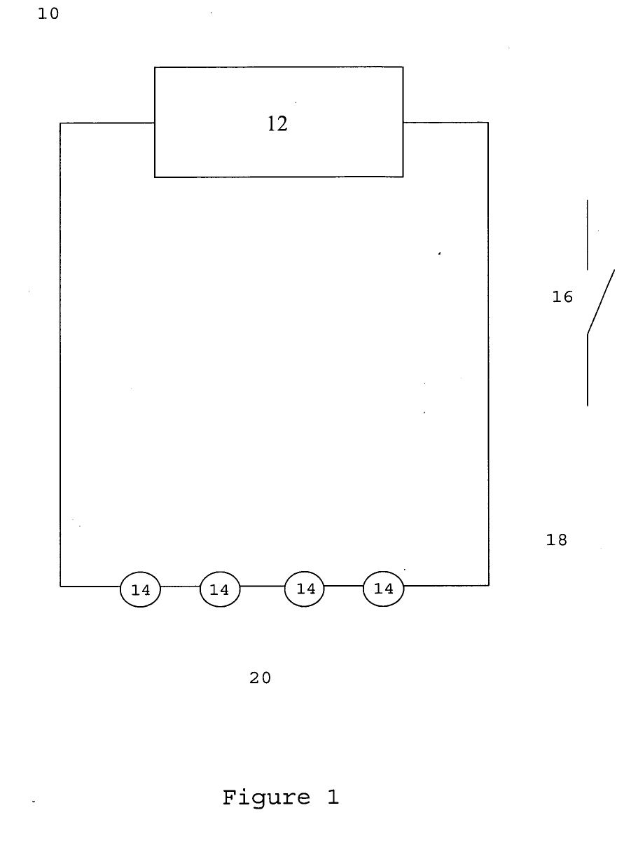

Accordingly, FIG. 1 describes one embodiment of the present invention. A fire fly emulation apparatus 10 is described in schematic view. A power source 12 is in electrical connection with a plurality of light sources 14. Each of the light sources 14 have control features for the control of light emission from the light source. In preferred embodiments, one control feature is the control of light emission from each light source in emulation of a light source, such as in some preferred embodiments a fire fly. Each of the plurality of light sources 14 therefore control the emulation of light emission of a fire fly in accordance with this embodiment of the invention. Counter to those traditional technologies previously discussed, the control of emulation of light emission of a fire fly is provided in the present invention by each of the light sources 14, not simply by other mechanical means such as view blocking elements such as attached disks, opaque materials, or other elements that may not even be considered emulation of fire fly light emission. Furthermore, by providing the control of emulation of light emission of a fire fly by each of the light sources 14, the present invention does not create the requirement for more complex hardware and software control independent of the light source that has been traditionally used.

Alternative embodiments of the present invention may emulate light emission of other light sources, such as other species that may emit light, or other decorative or functional light displays.

Again in reference to FIG. 1, each of the plurality of light sources in preferred embodiments each of the plurality of light sources control the emulation of light emission, and may control the emulation as an emulation of light emission of a fire fly at each of the light sources. As a light source, preferred embodiments have light sources 14 that are LEDs. Each of the LEDs may have integrated circuitry that control the emulation of light emissions of a fire fly, and in preferred embodiments, control the current at the LED for light emission accordingly.

In some embodiments, the light sources may each comprise a monolithically integrated transistor, and light sources may each be referred to as a monolithically integrated light emitting device. The device may have at least one monolithically integrated transistor in order to preferentially control the emulation of light emission of a fire fly as further described below. The use of monolithically integrated transistor LED design may not have been heretofore implemented in the emulation of light transmission from LED light sources.

Again, in reference to FIG. 1, the fire fly emulation apparatus may have further control elements, such as a power control element in electrical communication with the power source 12 and the plurality of light sources 14, control elements that may also serve in the emulation of light emission of fire flies. In some embodiments, the power control element may be an electrical switch, a toggle, a photo cell, a time, a remote control, or other known control elements. Power control element 16, exemplified as an electrical switch in FIG. 1, may be a component of apparatus 10 as alternatively presented in FIG. 1.

Furthermore, in some preferred embodiments, the fire fly emulation apparatus may have further control elements such as an adjustable resistance element 18, a feature that may control the current to each of the plurality of light sources that is in electrical communication with the power source 12 and each of the plurality of light sources 14. The adjustable resistance element may serve to control current to the plurality of light sources, and in some embodiments may throttle the current to the light sources in correspondence with the number of light sources provided as part of the fire fly emulation apparatus. The adjustable resistance helps to provide a consistent current and power to each of the light sources to facilitate the emulation of light emission, and as one example, allows for appropriate current flow depending upon the number of light sources 14. Adjustable resistance element 18, exemplified as a resistor in FIG. 1, may be a component of apparatus 10 as alternatively presented in FIG. 1. In some embodiments, the control of current generally of each of the light sources in the emulation of light transmission is a feature of the present invention.

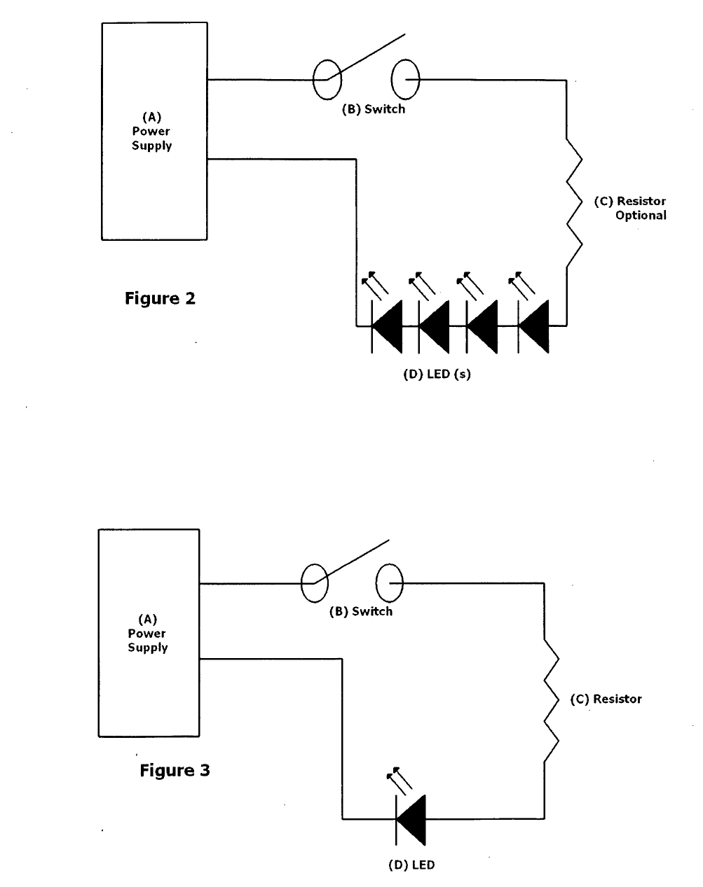

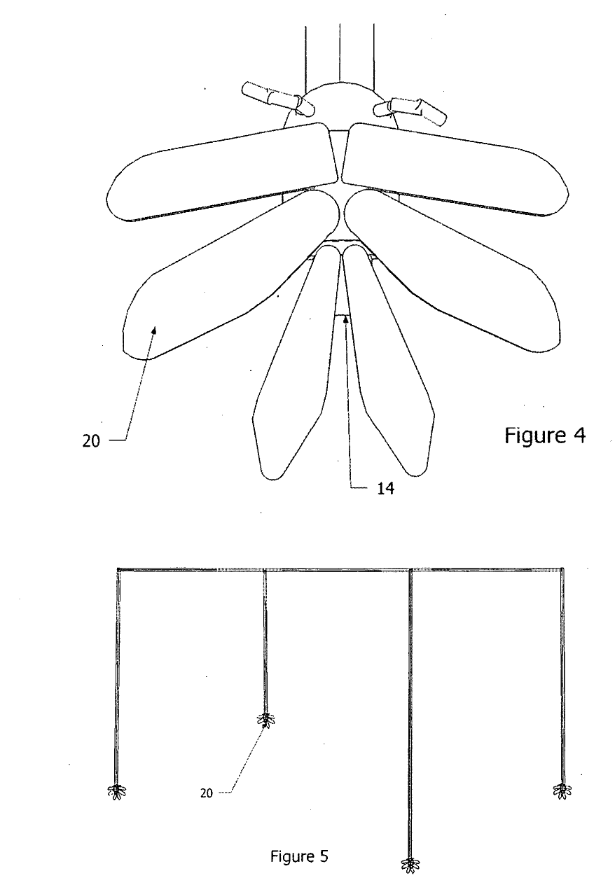

FIGS. 2 and 3 describe some preferred embodiments of the present invention with detail of some features and components of a fire fly emulation apparatus in accordance with the present invention.

Now in reference to the figures generally, the apparatus 10 may control the emulation of light emission of a fire fly, and in the instance of a plurality of light sources 14, multiple fire flies, by the features of each of the light sources 14. As may be known to those having studied the fire fly, the light emission may be considered to be represented by the timing of light emission, the duration of the light emission, and the ramping up or fading of light emission and light emission intensity of the fly. By the inclusion of control features of the light source, such as in the inclusion of current controlled elements of integrated circuitry of LEDs as the light sources, characteristics of light emission such as but not limited to the above characteristics of timing, duration, ramping up or fading of light emission and light emission intensity of the fly may be uniquely accomplished.

Now in reference to FIGS. 1 and 4, each of the light sources 14 may have a light source body 20 that emulates light emission of a fire fly. The light source body may preferentially emulate not simply the fire fly, but may importantly emulate the light transmission of the fire fly. In some embodiments, and as described and exemplified in FIG. 4, the emulation of light transmission may be facilitated by a light source body that is a fire fly body, and may even provide light emission from the abdomen or abdominal lantern of the fire fly body. FIG. 4 may further describe dimensions and features of one embodiment of the invention; however, these dimensions and features may be varied as one skilled in the art would appreciate.

According to some preferred embodiments, and in general reference to FIG. 1, the fire fly apparatus 10 may comprise a configuration as described and exemplified in FIG. 5. In some embodiments, the apparatus is a decorative display of light sources 14 in electrical connection, providing emulation of light emission of a fire fly, and moreover, light emission of a plurality of fire flies. In some embodiments, the fire fly emulation apparatus has a plurality of light sources that control the emulation of light emission of a fire fly, and when providing a plurality of light sources as described previously and as may be described in the figures such as FIGS. 1 and 5, the plurality of light sources serve to emulate a group of fire flies, and the light sources collectively emulation the group of fire fly light emissions.

As can be easily understood from the foregoing, the basic concepts of the present invention may be embodied in a variety of ways. It involves techniques as well as one or more apparatus or device that may provide for the appropriate techniques. In this application, the techniques of the present invention in some embodiments are disclosed as part of the results shown to be achieved by the various devices and several apparatus described and as steps that are inherent to utilization. They are simply the natural result of utilizing the devices, assemblages or several apparatus as intended and described. In addition, while some devices and apparatus are disclosed, it should be understood that these not only accomplish certain methods but also can be varied in a number of ways. Importantly, as to all of the foregoing, all of these embodiments are encompassed by this disclosure.

Further, each of the various elements or steps of the invention may also be achieved in a variety of manners. This disclosure should be understood to encompass each such variation, be it a variation of an apparatus embodiment, a method or process embodiment, or even merely a variation of any element of these. Particularly, it should be understood that as the disclosure relates to specific features of the invention, the words for each feature may be expressed by equivalent apparatus, device or method terms—even if only the function or result is the same. Such equivalent, broader, or even more generic terms should be considered to be disclosed for each element, step, or action. Such terms can be substituted where desired to make explicit the implicitly broad coverage to which this invention is entitled. As but one example, it should be understood that all actions or functions may be expressed as the function itself, a means for taking that action or achieving that function, or as an element which causes that action or has that function. Similarly, each element disclosed should be understood to encompass a disclosure of the action or function which is facilitated by that element.

Any acts of law, statutes, regulations, or rules mentioned in this application for patent; or any patents, publications, or other references mentioned in this application for patent are hereby incorporated by reference. In addition, as to each term used it should be understood that unless its utilization in this application is inconsistent with such interpretation as would be understood by one of ordinary skill in the art from this disclosure, common dictionary definitions should be understood as incorporated for each term and all definitions, alternative terms, and synonyms such as contained in the Random House Webster's Unabridged Dictionary, second edition are hereby incorporated by reference. However, as to each of the above, to the extent that such references, information or statements incorporated by reference might be considered inconsistent with the patenting of the invention, such as contradicting disclosed features ascertained by a reading of these patent documents, such information and statements are expressly not to be considered incorporated by reference and more particularly as not made by the Applicant. Furthermore, as to any dictionary definition or other extrinsic evidence utilized to construe this disclosure, if more than one definition is consistent with the use of the words in the intrinsic record, the claim terms should be construed to encompass all such consistent meanings.

Furthermore, if or when used, the use of the transitional phrase “comprising” is used to maintain “open-end” disclosure herein, according to traditional disclosure and claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

I claim:

1. A fire fly emulation apparatus, comprising:
a power source;
a plurality of light sources electrically connected with said power source;
wherein each of said plurality of light sources control the emulation of light emission of a fire fly.

2. A fire fly emulation apparatus as described in claim 1, wherein each of said plurality of light sources control the emulation of light emission of a fire fly at each light source.

3. A fire fly emulation apparatus as described in claim 2, wherein each of said plurality of light sources comprise an LED.

4. A fire fly emulation apparatus as described in claim 3, wherein each of said plurality of LEDs comprise integrated circuitry controlling the emulation of light emissions of a fire fly.

5. A fire fly emulation apparatus as described in claim 4, wherein said plurality of LEDs each comprise at least one monolithically integrated transistor.

6. A fire fly emulation apparatus as described in claim 1, further comprising a power control element in electrical communication with said power source and each of said plurality of light sources.

7. A fire fly emulation apparatus as described in claim 6, wherein said power control element comprises an element consisting of the group: an electrical switch, a toggle, a photo cell, a timer, a remote control.

8. A fire fly emulation apparatus as described in claim 1, further comprising an adjustable resistance element controlling current to each of said plurality of light sources and in electrical communication with said power source and each of said plurality of light sources.

9. A fire fly emulation apparatus as described in claim 1 wherein each of said plurality of light sources control the emulation of light emission of a fire fly by controlling current to each of said plurality of light sources.

10. A fire fly emulation apparatus as described in claim 1, wherein each of said plurality of light sources control the emulation of light emission of a fire fly by timing of said light emission.

11. A fire fly emulation apparatus as described in claim 1, wherein each of said plurality of light sources control the emulation of light emission of a fire fly by duration of said light emission.

12. A fire fly emulation apparatus as described in claim 1, wherein each of said plurality of light sources control the emulation of light emission of a fire fly by ramping of said light emission.

13. A fire fly emulation apparatus as described in claim 1, wherein each of said plurality of light sources control the emulation of light emission of a fire fly by fading of said light emission.

14. A fire fly emulation apparatus as described in claim 1, wherein each of said plurality of light sources comprises a light source body emulating light emission of a fire fly.

15. A fire fly emulation apparatus as described in claim 1, wherein each of said plurality of light sources comprises a fire fly body that is emulation of light emission of a fire fly.

16. A fire fly emulation apparatus as described in claim 1, wherein said apparatus is a decorative display of lights sources and light emission that is emulation of light emission of a fire fly.

17. A method of fire fly emulation, comprising the steps of:
providing a power source;
electrically connecting a plurality of light sources with said power source;
controlling the emulation of the light emission of each of said light sources;
emulating the light emission of a fire fly with each of said light sources;
whereby each of said plurality of light sources control the emulation of light emission of a fire fly.

18. A method of fire fly emulation as described in claim 17, wherein said step of controlling comprises controlling the emulation of light emission of a fire fly at each light source.

19. A method of fire fly emulation as described in claim 18, wherein each of said plurality of light sources comprise an LED, and wherein said step of controlling comprises controlling the emulation of light emission of a fire fly at each LED.

20. A method of fire fly emulation as described in claim 19, wherein each of said plurality of LEDs comprise integrated circuitry, and wherein said step of controlling comprises controlling the emulation of light emissions with said integrated circuitry.

21. A method of fire fly emulation as described in claim 20, wherein said plurality of LEDs each comprise at least one monolithically integrated transistor, and wherein said step of controlling comprises controlling the emulation of light emissions with said at least one monolithically integrated transistor.

22. A method of fire fly emulation as described in claim 17, further comprising the step of controlling power to each of said plurality of light sources.

23. A method of fire fly emulation as described in claim 17, further comprising the step of adjustably controlling current to each of said plurality of light sources.

24. A method of fire fly emulation as described in claim 23, wherein said step of adjustably controlling current comprises adjusting the resistance in the electrical communication of current with a power source and each of said plurality of light sources.

25. A method of fire fly emulation as described in claim 17, further comprising the step of controlling current by each of said plurality of light sources to each of said plurality of light sources to control the emulation of light emission of a fire fly.

26. A method of fire fly emulation as described in claim 17, wherein said step of controlling the emulation of the light emission of each of said light sources comprises controlling the emulation of light emission of a fire fly by timing of said light emission.

27. A method of fire fly emulation as described in claim 17, wherein said step of controlling the emulation of the light emission of each of said light sources comprises controlling the emulation of light emission of a fire fly by duration of said light emission.

28. A method of fire fly emulation as described in claim 17, wherein said step of controlling the emulation of the light emission of each of said light sources comprises controlling the emulation of light emission of a fire fly by ramping of said light emission.

29. A method of fire fly emulation as described in claim 17, wherein said step of controlling the emulation of the light emission of each of said light sources comprises controlling the emulation of light emission of a fire fly by fading of said light emission.

30. A method of fire fly emulation as described in claim 17, wherein said step of emulating comprises emulating the light emission from a light source body emulating light emission of a fire fly.

31. A method of fire fly emulation as described in claim 30, wherein said step of emulating comprises emulating the light emission from a fire fly body that is emulating light emission of a fire fly.

32. A method of fire fly emulation as described in claim 17, wherein said step of emulating comprises emulating the light emission of a fire fly as a decorative display of lights sources and light emission.

33. A fire fly emulation apparatus, comprising:
a power source;
a plurality of light sources electrically connected with said power source each having a current control element controlling current to said light source in emulation of light emission of a fire fly;
wherein each of said plurality of light sources control the emulation of light emission of a fire fly and wherein said plurality of light sources collectively control the emulation of individual light emissions of fire flies in emulation of a plurality of fire flies.
